(19) United States
(12) Patent Application Publication
(10) Pub. No.: US 2023/0264130 A1
(43) Pub. Date: Aug. 24, 2023

(54) FILTER ASSEMBLY WITH REULEAUX SEALING INTERFACE

(71) Applicant: Cummins Filtration Inc., Nashville, TN (US)

(72) Inventor: Lucas A. Canik, Edgerton, WI (US)

(73) Assignee: Cummins Filtration Inc., Nashville, TN (US)

(21) Appl. No.: 18/017,743

(22) PCT Filed: Jul. 22, 2021
(86) PCT No.: PCT/US2021/042780

§ 371 Date: Jan. 24, 2023

Related U.S. Application Data
(60) Provisional application No. 63/056,857, filed on Jul. 27, 2020.

(51) Int. Cl. B01D 46/24

(52) U.S. Cl. CPC B01D 46/2414; B01D 2201/304; B01D 2201/34; B01D 2265/026; B01D 2271/027

(57) ABSTRACT

A filter assembly of a fluid filtration system includes a filter housing and a filter element. The filter housing includes an engagement member. The filter element includes a media pack and a sealing member. The media pack includes filter media that is configured to filter a fluid passing therethrough. The sealing member is coupled to the media pack and is engageable with the engagement member. The sealing member is formed in a Reuleaux shape.

### CROSS-REFERENCE TO RELATED PATENT APPLICATIONS

This application is a National Phase of PCT Application No. PCT/US2021/042780, filed Jul. 22, 2021, which claims the benefit of and priority to U.S. Provisional Patent Application No. 63/056,857, filed Jul. 27, 2020. The contents of these applications are incorporated by reference in their entireties.

### TECHNICAL FIELD

The present disclosure relates generally to filtration products. More specifically, the present disclosure relates to sealing interface geometries for filtration products.

### BACKGROUND

In various applications, it is generally desirable to minimize an amount of particulate contamination in fluids used to power and lubricate an internal combustion engine. The amount of particulate contamination can be reduced by passing the fluids through a filter element or cartridge, which captures solid particles entrained within the fluid.

### SUMMARY

One embodiment of the present disclosure relates to a filter assembly. The filter assembly includes a filter housing and a filter element. The filter housing includes an engagement member. The filter element includes a media pack and a sealing member. The media pack includes filter media that is configured to filter a fluid passing therethrough. The sealing member is coupled to the media pack and is engageable with the engagement member. The sealing member is formed in a Reuleaux shape.

Another embodiment of the present disclosure relates to a filter element. The filter element includes a media pack and a sealing member. The media pack includes filter media that is configured to filter a fluid passing therethrough. The sealing member is coupled to the media pack. The sealing member is engageable with a filter housing to substantially prevent fluid flow past an interface between the sealing member and the filter housing. The sealing member is formed in a Reuleaux shape.

Another embodiment of the present disclosure relates to a filter housing. The filter housing includes a side wall, an end wall, and an engagement member. The side wall and the end wall together define an interior cavity. The end wall is disposed at a first end of the side wall. The engagement member is coupled to the end wall. The engagement member is configured to sealingly engage a sealing member of a filter element. The engagement member is formed in a Reuleaux shape.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1A is a perspective view of an example air filter element with an inward facing sealing member;

FIG. 1B is a cross-sectional view of an example air cleaner housing for use with the air filter element of FIG. 1A;

FIG. 2 is a diagram of construction lines for a first example shape of constant width;

FIG. 3 is a second example shape of constant width;

FIG. 4 is a third example shape of constant width;

FIG. 5A is a diagram of construction lines for a three-dimensional shape of constant width;

FIG. 5B are various example three-dimensional shapes of constant width;

FIG. 5C is a diagram of construction lines for a fourth example shape of constant width;

FIG. 6 is a perspective view of another example air filter element with an inward facing sealing member;

FIG. 7 is a perspective view of an example air filter element with an outward facing sealing member;

FIG. 8 is a perspective view of an example air filter element with an axially facing sealing member;

FIG. 9 is a top perspective view of an example axial flow filter element;

FIG. 10 is a bottom perspective view of the axial flow filter element of FIG. 9;

FIG. 11 is a perspective view of an example filter element cartridge that includes a sealing gasket;

FIG. 12 is a perspective view of another example filter element cartridge that includes a sealing gasket that is integrally formed with an end cap;

FIG. 13 is a perspective view of another example filter element cartridge that includes an inward facing sealing member;

FIG. 14 is a perspective view of an example spin-on filter element cartridge;

FIG. 15 is a perspective view of another example filter element that has a filter media pack in a racetrack shape;

FIG. 16 is a perspective view of another example filter element that has a filter media pack in a rectangular shape;

FIG. 17 is a perspective view of a square cut gasket formed in a Reuleaux shape of constant width;

FIG. 18 is a perspective view of a gasket having a Reuleaux-shaped cross-section that is formed in a circular shape;

FIG. 19 is a cross-sectional view of the gasket of FIG. 18;

FIG. 20 is a perspective view of another filter element with an axially facing sealing member;

FIG. 21 is a cross-sectional view of a gasket of the filter element of FIG. 20;

FIG. 22 is a perspective view of another filter element that has an end cap with a non-circular shape of constant width;

FIG. 23 is a top view of the end cap of FIG. 22;

FIG. 24 is a perspective view of another example filter element that includes an angled sealing gasket;

FIG. 25 is a side view of the filter element of FIG. 24;

FIG. 26 is a top view of another example filter element that includes a truncated sealing gasket;

FIG. 27 is a perspective view of another example filter element that includes a truncated and angled sealing gasket;

FIG. 28 is a perspective view of another example filter element cartridge that includes an angled sealing gasket;

FIG. 29 is a side view of another example filter element cartridge that includes multiple angled sealing gaskets;

FIG. 30 is a partial perspective view of an example air cleaner assembly;

FIG. 31 is a partial front view of the air cleaner assembly of FIG. 30;

FIG. 32 is a side cross-sectional view of the air cleaner assembly of FIG. 30;

FIG. 33 is a perspective view of a primary filter element of the air cleaner assembly of FIG. 30;

FIG. 34 is a top view of the primary filter element of FIG. 33;

FIG. 35 is a perspective view of a secondary filter element of the air cleaner assembly of FIG. 30;

FIG. 36 is a front view of the secondary filter element of FIG. 35;

FIG. 37 is a perspective view of a housing of the air cleaner assembly of FIG. 30;

FIG. 38 is a front view of the housing of FIGS. 37; and

FIG. 39 is perspective view of another secondary filter element.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for sealing a filter element to a fluid filtration system. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Internal combustion engine systems require clean fluids (e.g., fuel, air, oil, etc.) to power and/or lubricate the engine. Unfiltered fluids may include dirt, metal particles, and other solid contaminants that can damage engine components (e.g., fuel injectors, cylinder rings, pistons, etc.). In order to protect the engine components, many internal combustion engine systems include filtration systems, which filter incoming and/or recirculating fluids to remove any solid materials before passing the fluids to the engine. The filtration system may include a housing, a filter head, and a filter element. In operation, the filtration system directs the fluid through the filter element, which includes a media that captures any solid particulate entrained in the fluid. The filtration system may also include sealing elements and/or interfaces to sealingly engage the filter element to the housing and/or filter head and substantially prevent solid materials from bypassing the filter element. It is generally desirable to remove as many contaminants from the fluid as possible without significantly impacting the pressure drop across the fluid flow system. The performance of the filtration system depends, among other factors, on the structure of the filter element and the materials used to construct the filter element (e.g., the materials used to produce a filter media for the filter element), the specifications of the filter media pack such as the flow area of the filter media pack, the pleat depth of the filter media pack, and other factors.

Over time, accumulated particulate on the filter element (e.g., carbon, dust, metal particles, etc.) can increase the pressure drop across the filter element (and, correspondingly, a pressure drop across a fluid delivery and/or recirculation system for the engine). In order to reduce the pressure drop, the filter element can be removed from the filtration system and replaced with a clean filter element. In some instances, a user may elect to replace the filter element with a non-genuine filter element; for example, in order to reduce maintenance costs. However, the filtration performance of the non-genuine filter elements can be much lower than an OEM filter element. Over time, operating with the non-genuine filter element may result in damage to the injectors and/or other parts of the engine, thereby leading to a reduction in engine performance.

Implementations herein relate to methods and systems including a unique sealing element geometry and/or sealing interface geometry between a filter element and other parts of the filtration system. In particular, implementations herein relate to sealing interface geometries that are formed in Reuleaux shapes, which are closed convex curves having a constant cross-sectional width between two parallel lines on opposing sides of the Reuleaux shape. Among various benefits, using Reuleaux shapes can help to prevent the use of non-OEM filter elements that could result in damage to various engine components, which further result in increased warranty costs. The Reuleaux shapes can be applied to a variety of filtration products across different product lines (e.g., air filtration, fuel filtration, lube filtration, crankcase ventilation, etc.) without significantly modifying the design of the filtration products. Additionally, the Reuleaux shapes can be scaled infinitely in size to accommodate filtration products for varying applications and/or across an entire family of products, without extensive changes to existing components. Because the number of Reuleaux shapes is also infinite, there are no limits to the number of unique sealing interface variations that can be applied to different filtration products.

In some embodiments, the Reuleaux geometry can be applied to sealing elements and/or interfaces that at least partially define an inlet and/or outlet opening of a filter element. Because Reuleaux shapes have a constant cross-sectional width between parallel lines on opposing sides of the Reuleaux shape, using a Reuleaux shape minimizes flow restriction relative to other non-circular cross-sectional shapes for an equivalent flow area (e.g., the hydraulic diameter and/or the ratio of the flow area to the perimeter is greater for Reuleaux shapes than other non-circular shapes). Circular tubing may also be more easily adapted to transition to a Reuleaux shape (e.g., tubing that transitions from a circular shape to Reuleaux shape) as compared to other non-circular shapes without significantly impacting pressure drop across the tubing. Additionally, Reuleaux shapes facilitate “clocking” (e.g., rotational alignment) between the filter element and the filter housing, which may be important in some embodiments and cannot be accomplished with circular-shaped sealing interfaces on their own.

In some embodiments, the sealing element is a gasket that is formed into a Reuleaux shape (e.g., a closed convex curve having a central opening, where the closed curve forms a Reuleaux shape). A cross-section of the gasket (e.g., a cross-section taken through the gasket along a plane that is substantially parallel to and extends through a central axis of the central opening) may also be formed into a Reuleaux shape. Forming the gasket with a Reuleaux-shaped cross-section ensures a constant cross-sectional thickness of the gasket (subject to standard manufacturing tolerances), which promotes uniform contact between the gasket and the sealing surfaces. The constant cross-sectional thickness also ensures consistent spacing between the filter element and housing is maintained when using different shapes (e.g., different Reuleaux shapes having the same thickness).

### II. Example Filter Element

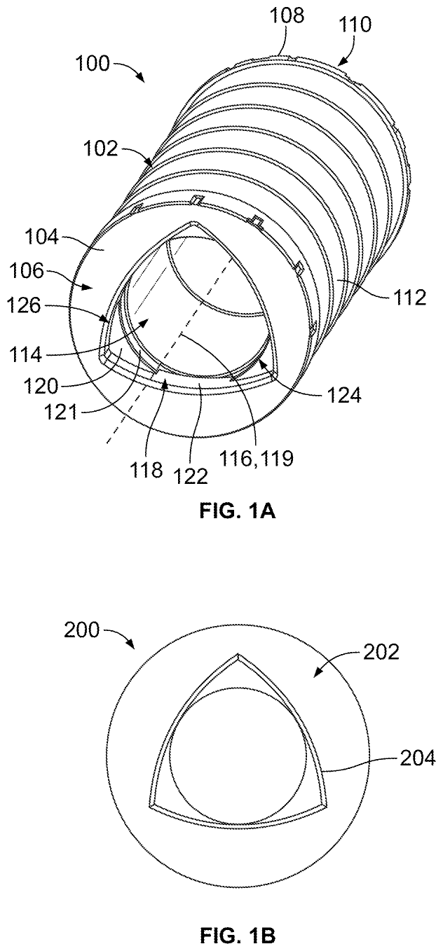

FIG. 1A is a perspective view of a first example filter element 100 of a filtration system. The filter element 100 is an air filter element used to filter air entering an internal combustion engine, to prevent dust particles, bugs, dirt, and other contaminants from entering the internal combustion engine. In other embodiments, the filter element may be another type of filter used to clean incoming and/or recirculating fluids. For example, the filter element may be a fuel filter used to remove contaminants (e.g., water and/or solid particulate) from fuel used to power the engine (e.g., diesel fuel, gasoline, etc.), an oil filter used to filter lube oil that is recirculated through parts of the internal combustion engine system, a crankcase ventilation filter used to remove oil (e.g., aerosol vapors and oil droplets) and other contaminants from crankcase blow-by gases, or another filter type. In some embodiments, the filter element may be part of a filtration system for a non-engine application such as a hydraulic system or any other application using a fluid which must be cleaned of contaminants and debris.

The filter element 100 (FIG. 1A) is sized and shaped to be received within a filter housing 200 (FIG. 1B) (e.g., within a hollow portion 202 of the filter housing 200) and is detachably coupled to the filter housing 200. As shown in FIG. 1A, the filter element 100 is a replaceable filter cartridge that is replaced periodically as the filter element 100 loads with dust and other contaminants. The filter element 100 includes a media pack 102, a first end cap 104 disposed at a first end 106 of the media pack 102, and a second end cap 108 disposed at a second end 110 of the media pack 102 opposite from the first end 106.

The filter element 100 of FIG. 1A is a cylindrically-shaped filter cartridge having a cylindrically-shaped media pack, shown as media pack 102. In other embodiments, the cross- sectional shape of the filter element 100 and/or media pack 102 may be different. The media pack 102 includes a filter media 112 that is configured to filter particulate matter and/or other contaminants from a fluid flowing therethrough so as to produce a filtered fluid (e.g., a clean fluid). The filter media 112 may include a porous material having a predetermined pore size. The filter media 112 may include a paper-based filter media, a fiber-based filter media, a foam-based filter media, or the like. The filter media 112 may be pleated or formed into another desired shape to increase a flow are through the media pack 102, or to otherwise alter the particle removal efficiency of the filter element 100. The filter element 100 may be arranged as an outside-in flow filter element having an outer dirty side and an inner clean side. In an alternative arrangement, the filter element 100 is an inside-out filter element having an inner dirty side and an outer clean side. Fluid to be filtered passes from the dirty side of the filter element 100 to the clean side of the filter element 100. In the embodiment of FIG. 1A, the filter element 100 is a radial flow filter element in which flow passes in a substantially radial direction through the media pack 102. In other embodiments, the media pack 102 may be arranged such that flow passes in an axial direction (e.g., a longitudinal direction parallel to the central axis 116) through the media pack 102 or at least partially in an axial direction.

In some embodiments, the media pack 102 is formed by filter media having a plurality of interdigitated tetrahedral forms. The media pack extends axially (e.g., in an axial direction) between an upstream inlet and a downstream outlet along a plurality of bend lines. The bend lines taper in a transverse direction. In one embodiment, the bend lines include a first set of bend lines extending from the upstream inlet axially towards the downstream outlet, and a second set of bend lines extending from the downstream outlet axially towards the upstream inlet. The media pack may have a plurality of wall segments extending in serpentine manner between said bend lines that extend axially and define a common volume therebetween. The common volume may have a height along a transverse direction (e.g., a direction that is perpendicular to the axial direction) and a lateral width along a lateral direction (e.g., a direction that is perpendicular to both the axial direction and the transverse direction). At least some of the bend lines may taper in the transverse direction as they extend axially in said axial direction. The wall segments that extend in the serpentine manner may define a laterally extending serpentine span including a first wall segment laterally adjacent to a second wall segment and joined thereto by a first bend line. The wall segments may continue in the serpentine manner along the serpentine span to a third wall segment that is laterally adjacent to the second wall segment and joined thereto by a second bend line, and so on along the serpentine span. The serpentine span may extend along the lateral direction, such that the taper of the bend lines tapering in the transverse direction is perpendicular to the serpentine span along the lateral direction. The wall segments may include a first set of wall segments alternatively sealed to each other at the upstream inlet to define a first set of forms having open upstream ends, and a second set of forms interdigitated with the first set of forms and having closed upstream ends. The wall segments may include a second set of wall segments alternately sealed to each other at the downstream outlet to define a third set of forms that have closed downstream ends, and a fourth set of forms interdigitated with the third set of forms and having open downstream ends. The first set of bend lines may include a first subset of bend lines defining the first set of forms, and a second subset of bend lines that define the second set of forms. The second subset of bend lines may taper in the transverse direction as they extend from the upstream inlet axially towards the downstream outlet. The second set of bend lines may include a third subset of bend lines defining the third set of forms, and a fourth subset of bend lines defining the fourth set of forms. The fourth subset of bend lines may taper in the transverse direction as they extend from the downstream outlet axially towards the upstream inlet. Such tetrahedral media pack geometry is described in detail in U.S. Pat. No. 8,397,920, the contents of which are incorporated herein by reference.

The filter element 100 defines a central opening 114 extending along a central axis 116 (e.g., a longitudinal axis, etc.) of the filter element 100. In some embodiments, the central opening 114 is sized to receive a central support tube therein. The support tube is configured to improve the strength of the filter element 100 under compressive loading (e.g., due to an air pressure differential across the media pack 102). In other embodiments, as shown in FIG. 1A, the filter element 100 does not include a support tube, but rather includes a spiral bead of hot melt (e.g., glue or another adhesive product) extending in a longitudinal direction (e.g., an axial direction that is parallel to the central axis 116) across both the clean and dirty sides of the filter element 100 (e.g., inner and outer surfaces of the media pack 102) between the first end 106 and the second end 110.

As shown in FIG. 1A, the first end cap 104 defines a sealing member 118 having a Reuleaux geometry. The first end cap 104 may be molded or otherwise formed onto the first end 106 of the media pack 102 and may seal the first end 106 of the media pack 102 (e.g., seal a clean side of the media pack from a dirty side of the media pack at the first end 106). In other embodiments, the first end cap 104 is overmolded onto an existing end cap 120 at the first end 106. In yet other embodiments, the first end cap 104 is a separate piece from the filter element 100 that is press fit over the existing end cap 120. As shown in FIG. 1A, the first end cap 104 includes an extension piece 122 (e.g., tab, tang, etc.) that engages with an opening 124 in the existing end cap 120 along an inner perimeter portion 121 of the opening 124 to facilitate alignment between the sealing member 118 in the first end cap 104 and the opening 124 (e.g., such that a central axis 119 of the sealing member 118 is substantially collinear with the central axis 116 of the filter element 100). The extension piece 122 extends away from a lower surface (not shown) of the first end cap 104 toward the central opening 114 in a longitudinal direction that is parallel to the central axis 116 of the filter element 100. In some embodiments, the first end cap 104 includes multiple extension pieces that engage with different parts of the opening 124. For example, the first end cap 104 may include a plurality of extension pieces that are spaced apart in approximately equal intervals along the lower surface in a circumferential direction. In other embodiments, the arrangement of the extension pieces may be different. In yet other embodiments, the first end cap 104 does not include an extension piece 122.

The sealing member 118 is a radial sealing element that faces radially inward toward the central axis 116 of the filter element 100. As shown in FIG. 1A, the sealing member 118 is formed by a through-hole opening 126 extending through the first end cap 104. A cross-section of the through-hole opening 126 along a plane perpendicular to the central axis 116 forms a Reuleaux shape. In the embodiment of FIG. 1A, the cross-sectional shape of the through-hole opening 126 is a Reuleaux triangle having three outer edges and three vertices. In other embodiments, the cross-sectional shape of the through-hole opening 126 may form a different Reuleaux shape. Together, the through-hole opening 126 in the first end cap 104 and the opening 124 in the existing end cap 120 define an inlet and/or outlet of the filter element 100. As compared to other non-circular shapes, the Reuleaux shape provides the greatest flow area to perimeter ratio, which reduces pressure drop and the overall footprint of the sealing interface between the filter element 100 and the filter housing. As shown in FIG. 1A, each edge (e.g., side, etc.) of the Reuleaux triangle is extends along, and is tangent to, at least a portion of the perimeter edge of the opening 124 in the existing end cap 120. In some embodiments, a width of the through-hole opening 126 in the first end cap 104 is approximately equal to or greater than a width of the opening 124 in the existing end cap 120, which, advantageously, maximizes the flow area (and minimizes flow restriction) into or out of the filter element 100.

The sealing member 118 (e.g., first end cap 104) may be produced from a metal or plastic material via molding (e.g., of a urethane or another curable plastic), injection molding, extrusion, overmolding, additive manufacturing, machining, stamping, pressing, or another suitable manufacturing method. The sealing member 118 may be formed from a soft urethane material or another suitable plastic and/or rubber material.

As shown in FIG. 1B, the hollow portion 202 of the filter housing 200 is sized to receive the filter element 100 therein and to direct the flow of fluid through the filter element 100. The filter housing 200 includes an engagement member that is configured to sealingly engage the sealing member 118. In the embodiment of FIG. 1B, the engagement member is an inner flange 204 that is sized to sealingly engage the sealing member 118 in the first end cap 104. The inner flange 204 is a protrusion that extends away from an end of the filter housing 200 in an axial direction (e.g., parallel to a central axis of the filter housing 200, in a direction that is substantially perpendicular to the end of the filter housing 200). A cross-sectional shape of the inner flange 204 is the same as (e.g., complementary to) the cross-sectional shape of the through-hole opening 126 in the first end cap 104 (FIG. 1A). In other words, the cross-sectional shape of the inner flange 204 is also a Reuleaux triangle. An outer width of the Reuleaux triangle formed by the inner flange 204 is approximately the same as an inner width of the Reuleaux triangle formed by the through-hole opening 126 in the first end cap 104, such that the inner flange 204 presses and seals against the sealing member 118 in the first end cap 104 when the filter element 100 is engaged with the filter housing 200. In other embodiments, and for different filtration products, the design of the engagement member of the filter housing may be different.

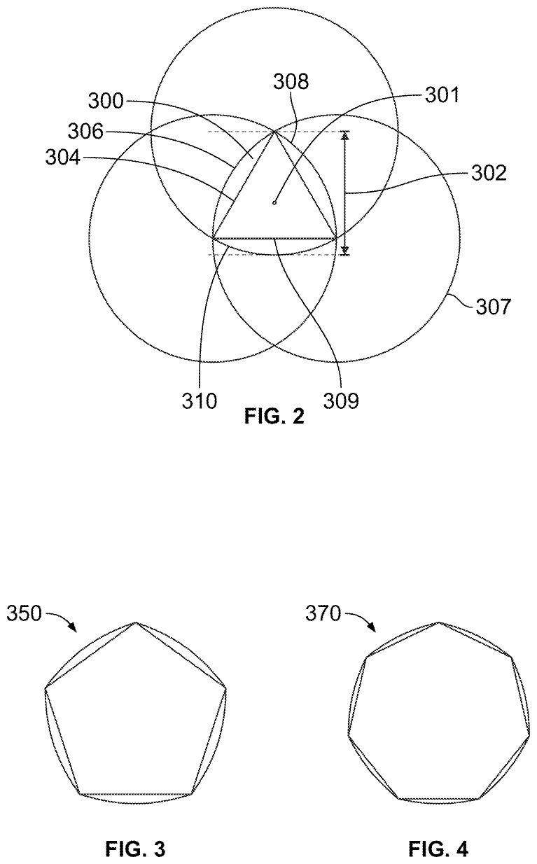

FIG. 2 shows construction lines for a Reuleaux shape, shown as Reuleaux triangle 300. As shown in FIG. 2, the width 302 of the Reuleaux shape corresponds to the distance between two parallel lines positioned on opposing sides of the Reuleaux shape that each contact the boundary of the Reuleaux shape. The Reuleaux shape is created starting with an equilateral polygon with an odd number of edges, in this case an equilateral triangle 304. A first arc 306 is drawn that connects two adjacent vertices of the equilateral triangle 304. As shown in FIG. 3, the first arc 306 is a portion of a circle 307 that is centered on an opposing vertex of the equilateral triangle 304 as the first arc 306. A radius 309 of the first arc 306 corresponds to the straight-line distance between adjacent vertices of the equilateral triangle 304. This arc construction operation is repeated for a second arc 308 and a third arc 310 on the remaining sides of the equilateral triangle 304 to form a closed convex curve in the shape of the Reuleaux triangle 300. As shown in FIGS. 3-4, a similar construction operation may be performed with other odd-sided equilateral polygons having a greater number of edges than a triangle, such as five edges for the five-sided Reuleaux shape 350 shown in FIG. 3, seven edges for the seven-sided Reuleaux shape 370 shown in FIG. 4 or more as provided in equation (1) below:

N=3, 5, 7 . . . (infinity−1) (1)

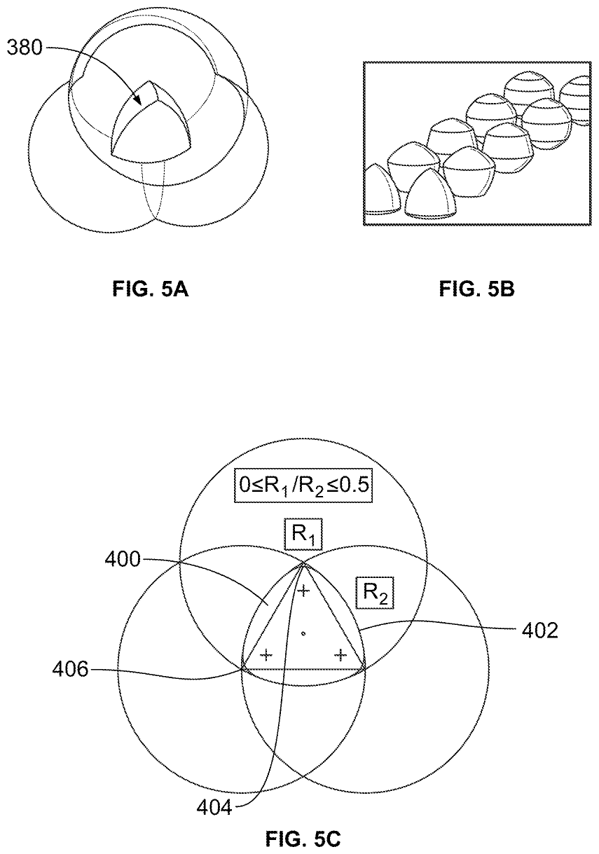

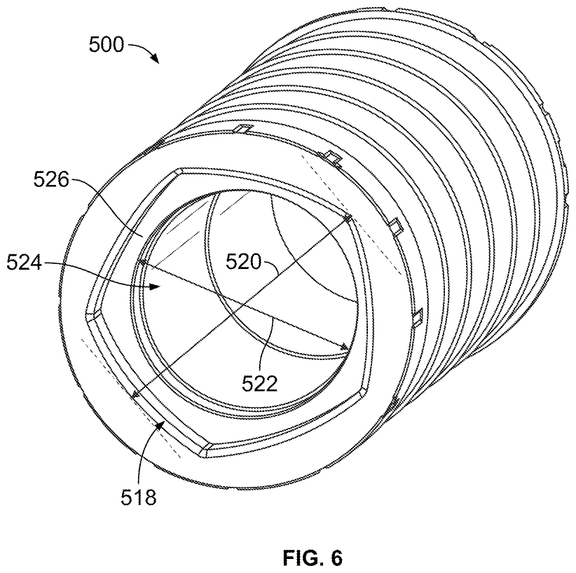

The construction methodology introduced above can also be expanded to three dimensional shapes that share similar properties as their two-dimensional counterparts (e.g., constant width across the volume of the Reuleaux body relative to the center point of the Reuleaux body, etc.). For example, FIGS. 5A and 5B show a variety of three-dimensional Reuleaux shapes including a four-sided Reuleaux tetrahedron 380 (FIG. 5A) and other three-dimensional Reuleaux shapes having a greater number of side surfaces (FIG. 5B).

In some embodiments, the Reuleaux shape may include rounded corners (e.g., rounded and/or curved edges, reliefs, etc.) rather than sharp corners at each vertex. For example, FIG. 5C shows a Reuleaux triangle 400 that includes side edges 402 and rounded edges 404 that connect the side edges 402 at the location of each vertex 406. As shown in FIG. 5C, a radius R1 of each one of the rounded edges 404 is less than a radius R2 of each one of the side edges 402. In one embodiment, the radius R1 of each of the rounded edges 404 is selected such that the rounded edges 404 are approximately tangent with the side edges 402 where they contact the side edges 402. In the embodiment of FIG. 5C, the radius R1 of each of the rounded edges 404 is determined such that the ratio of the radius R1 over the radius R2 is within a range between approximately 0 and 0.5 (e.g., 0≤R1/R2≤0.5), although in other embodiments the relationship between the radius R1 and the radius R2 may be different. Among other benefits, using rounded corners at each vertex improves fitment between the filter element and the filter housing and/or other components of the filtration system (e.g., a secondary filter, etc.) and provides additional Reuleaux shapes variants.

The design and size of the Reuleaux geometry of FIG. 1A is shown for illustrative purposes only. Many alternatives and combinations are possible without departing from the inventive principles disclosed herein. For example, FIG. 6 is a perspective view of a second example filter element 500 that includes a sealing member 518 forming a five-sided Reuleaux shape having five curved edges and five vertices. A width 520 of the five-sided Reuleaux shape is greater than a width 522 (e.g., diameter) of an inlet/outlet opening 524 in an existing end cap 526, which, advantageously, reduces the pressure drop associated with the sealing member 518 across the inlet/outlet opening 524.

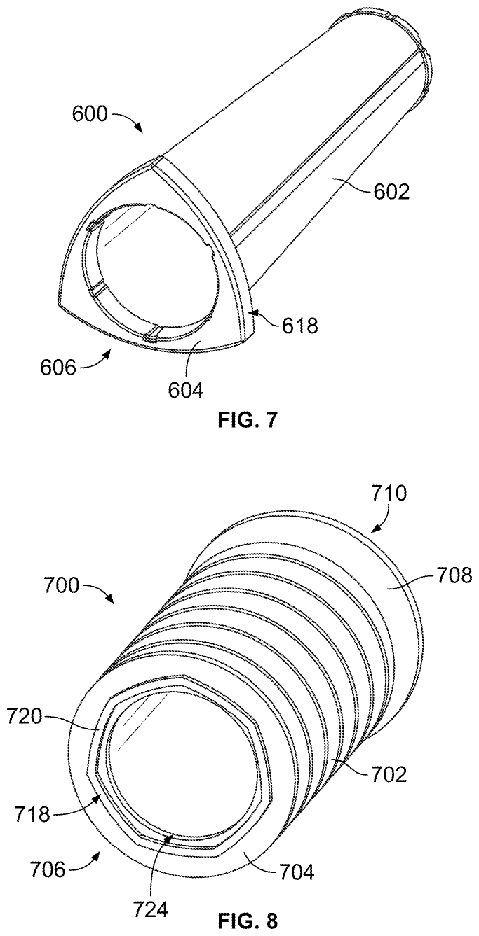

A Reuleaux sealing member may also be used in other sealing configurations including, but not limited to, radially outward facing sealing members, axially facing sealing members, and others. For example, FIG. 7 shows a secondary filter element 600 (e.g., inner filter element) for a filtration system that includes a first end cap 604 defining a radially outward facing sealing member (shown as sealing member 618) in the shape of a Reuleaux triangle. In other embodiments, the Reuleaux shape formed by the sealing member 618 may be different. The secondary filter element 600 is sized to be received within a central opening (e.g., central opening 114 of FIG. 1A) of a primary filter element (e.g., an outer filter element, a main filter element, etc.). In the embodiment of FIG. 7, the first end cap 604 is coupled to a first end 606 of the secondary filter element 600 (e.g., the media pack 602) and seals a clean side of the media pack 602 from a dirty side of the media pack 602 at the first end 606. The sealing member 618 is integrally formed with the first end cap 604 as a single unitary body. The sealing member 618 is formed along an outer perimeter of the first end cap 604 and is configured to sit within and sealingly engage a complementary sealing member on the primary filter element.

FIG. 8 shows a third example filter element 700 that includes an axially facing sealing member 718. The filter element 700 includes a media pack 702, a first end cap 704 disposed at a first end 706 of the media pack 702, and a second end cap 708 disposed at a second end 710 of the media pack 702 that is opposite from the first end 706. As shown in FIG. 8, the first end cap 704 defines a substantially circular inlet/outlet opening, shown as inlet/outlet opening 724, for the filter element 700. As shown in FIG. 8, the axially facing sealing member 718 is a square cut gasket, shown as gasket 720 (e.g., a gasket having a cross-sectional shape that is substantially rectangular). The gasket 720 engages an outward, axially facing surface of the first end cap 704 and surrounds the inlet/outlet opening 724. In one embodiment, the gasket 720 is a separate piece of material from the first end cap 704 (e.g., a soft urethane material) that is glued or otherwise bonded to the first end cap 704 (e.g., a hard urethane material).

As shown in FIG. 8, the gasket 720 is formed in a seven-sided Reuleaux shape having seven edges and seven vertices. A width of the gasket 720 is greater than a width of the inlet/outlet opening 724 to ensure complete sealing against a filter housing at the first end 706. In the embodiment of FIG. 8, the gasket 720 sealingly engages a sealing surface within the filter housing that also has a five-sided Reuleaux shape, which prevents non-genuine filter elements from being installed in place of filter element 700.

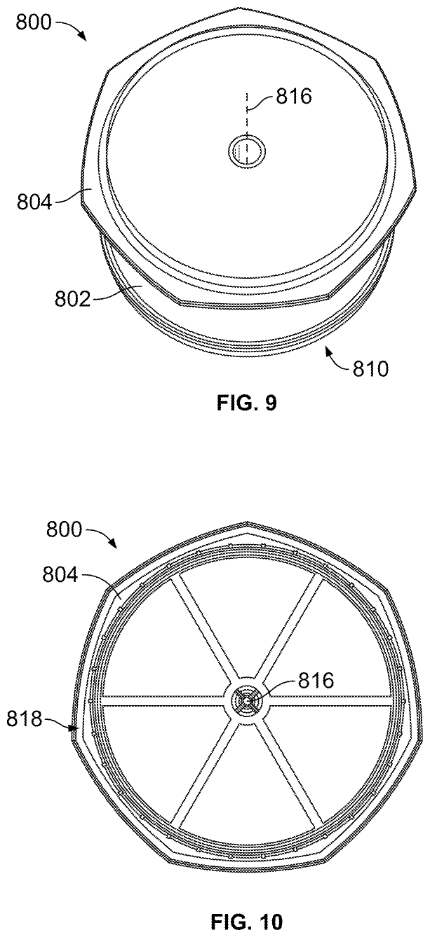

FIGS. 9-10 show an axial flow filter element, shown as filter element 800, in which flow passes through the media pack 802 in a substantially axial direction (e.g., a longitudinal direction parallel to a central axis 816 of the filter element 800). The media pack 802 may be formed from a corrugated media or another non-pleated filter media. The filter element 800 includes a flange 804 that extends in a substantially radial direction away from the media pack 802 such that at least a portion of the flange 804 is disposed at a larger radial position than the media pack 802. As shown in FIG. 9, the flange 804 is disposed at an intermediate longitudinal position between opposing ends of the media pack 802. The flange 804 is disposed proximate to a first end of the media pack 802, but may be disposed in a central position, or another intermediate position in other embodiments. In one embodiment, the flange 804 is “sandwiched” or otherwise disposed between two separate portions of the media pack 802 (e.g., a first media pack and a second media pack that is separate from the first media pack).

As shown in FIG. 10, the flange 804 includes a sealing member 818 disposed on a lower surface of the flange 804 and that faces axially toward a second end 810 of the filter element 800. The sealing member 818 extends along an outer perimeter of the flange 804. In the embodiment of FIG. 10, the sealing member 818 is a square cut gasket having a substantially rectangular cross-section. The sealing member 818 may be bonded or otherwise coupled to the flange 804. In other embodiments, the sealing member 818 may be integrally formed with the flange 804 as a single unitary body. As shown in FIG. 10, both the flange 804 and the sealing member 818 form a seven-sided Reuleaux shape having seven edges and seven vertices. Among other benefits, using the same shape for the flange 804 and the sealing member 818 minimizes an amount of material that is required for the flange 804. In some embodiments, the flange 804 may be received within a recessed area and/or inner flange of the filter housing that is shaped to accommodate the flange 804 to prevent fitment between non-genuine filter elements and the housing (e.g., to prevent the filter element from being fully inserted into the housing, etc.). In other embodiments, the shape formed by an outer perimeter edge of the flange 804 may be different from the shape of the sealing member 818 (e.g., the flange 804 may be substantially circular, etc.).

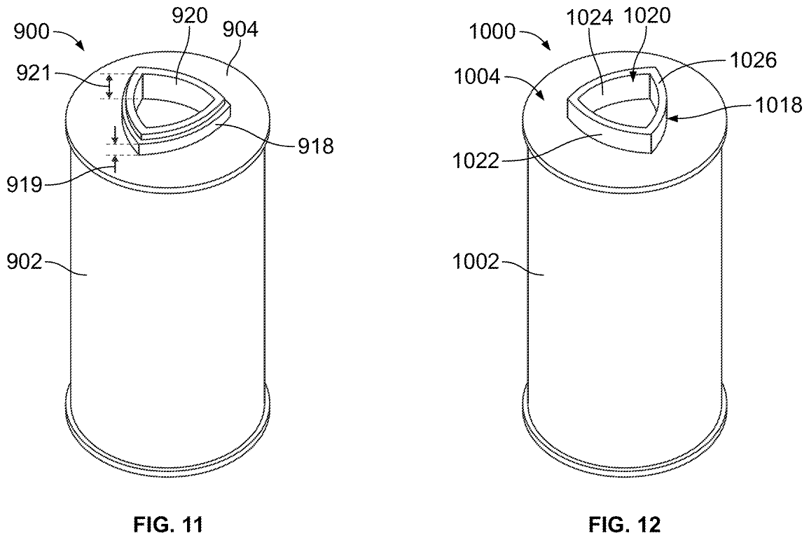

In some embodiments, the sealing member is a gasket that is formed separately from an end cap of the filter element, which may be inserted onto the filter element before installing the filter element into a filter housing. For example, FIG. 11 shows an example filter element 900 that includes a Reuleaux-shaped gasket, shown as gasket 918, engaged with an extension 920 of the end cap 904. The extension 920 is integrally formed with the end cap 904 and extends in an axial direction away from the end cap 904 (e.g., vertically upward from the end cap 904 as shown in FIG. 11, parallel to a central axis of the end cap 904, etc.). The extension 920 is disposed at a central position along a side of the end cap 904 that is opposite from the media pack 902 (e.g., an upper side, outer side, etc.), such that the extension 920 extends away from the media pack 902 in the axial direction. The extension 920 defines an inlet/outlet opening of the filter element 900 (e.g., a perimeter of the inlet/outlet opening) through which fluid may enter or leave the filter element 900 depending on the configuration of the filter element 900. The extension 920 forms a Reuleaux shape when viewed from above the extension (e.g., a top view of the extension 920 looking into the inlet/outlet opening). A cross-sectional shape of the extension 920, along a plane that is oriented perpendicular to the central axis of the filter element 900, is a Reuleaux triangle. The gasket 918 is disposed over the extension 920 and surrounds the extension 920. A lower surface of the gasket 918 engages the end cap 904 (e.g., the upper side) when fully installed onto the end cap 904. A height 919 of the gasket 918 in the axial direction is less than a height 921 of the extension 920 such that the extension 920 protrudes upwardly from the gasket 918 when the gasket is engaged with the end cap 904. In other embodiments, the gasket 918 may be positioned at an intermediate position between an upper and lower end of the extension 920 or proximate to the upper end of the extension 920. In some embodiments, the height of the gasket 918 is approximately the same as the height of the extension 920. As shown in FIG. 11, the gasket 918 is also formed in a Reuleaux shape (e.g., a Reuleaux triangle), which is the same shape as the extension 920. The gasket 918 is rotationally aligned with the extension 920 so that the shape of the gasket 918 is not distorted when it is installed onto the extension 920. A surface along an outer perimeter of the gasket 918 defines a sealing member that faces radially outward and away from the media pack 902. In the embodiment of FIG. 11, the media pack 902 may be a coalescer for a crankcase ventilation system.

FIG. 12 shows a filter element 1000 that is similar in shape to the filter element 900 of FIG. 11, but where the sealing member 1018 is defined by one, or a combination of (i) the surfaces extending along an outer perimeter of the extension 1020 (e.g., a radially outward facing sealing member defined by the outer side surfaces 1022 of the extension 1020); (ii) the surfaces extending along an inner perimeter of the extension 1020 (e.g., a radially inward facing sealing member defined by the inner side surfaces 1024 of the extension 1020); (iii) and a surface 1026 along an upper axial end of the extension 1020 (e.g., an axially facing sealing member). The extension 1020 is integrally formed with the end cap 1004 as a single unitary body and extends in an axial direction away from the end cap 1004 (e.g., vertically upward from the end cap 1004 as shown in FIG. 12, parallel to a central axis of the end cap 1004, etc.). The extension 1020 is disposed at a central position along a side of the end cap 1004 that is opposite from the media pack 1002 (e.g., an upper side, outer side, etc.), such that the extension 1020 extends away from the media pack 1002 in the axial direction. The extension 1020 defines an inlet/outlet opening of the filter element 1000 (e.g., a perimeter of the inlet/outlet opening) through which fluid may enter or leave the filter element 1000 depending on the configuration of the filter element 1000. The extension 1020 forms a Reuleaux shape when viewed from above the extension (e.g., a top view of the extension 1020 looking into the inlet/outlet opening). A cross-sectional shape of the extension 1020, along a plane that is oriented perpendicular to the central axis of the filter element 1000, is a Reuleaux triangle. The extension 1020 (and end cap 1004) may be formed of a soft urethane material such as polyurethane, or another suitably compliant and fluid impermeable material to sealingly engage a filter housing.

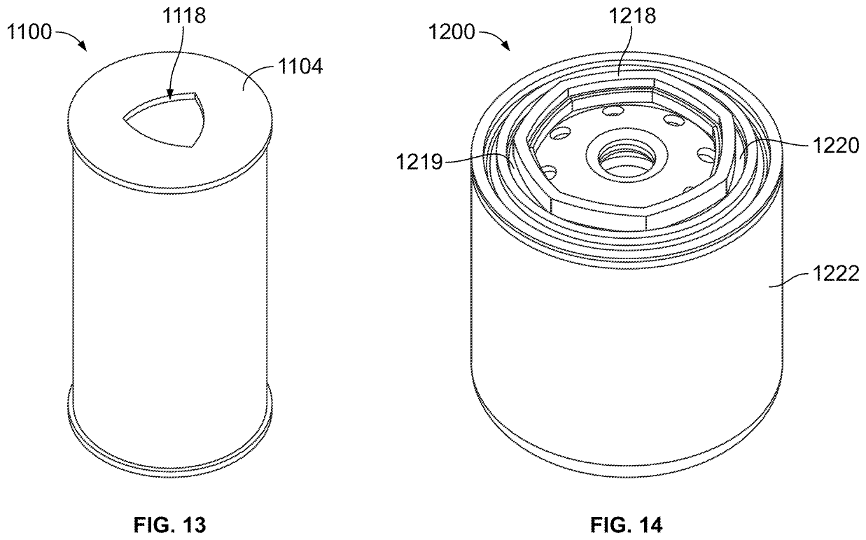

FIG. 13 shows a filter element 1100 that includes an inward facing sealing member, shown as sealing member 1118, that is integrally formed with an end cap 1104 of the filter element 1100. The sealing member 1118 defines an inlet/outlet opening of the filter element 1100. The sealing member 1118 is defined by a Reuleaux-shaped opening extending through the end cap 1104 from a first/outer side of the end cap 1104 to a second/inner side of the end cap 1104. In the embodiment of FIG. 13, the opening is shaped as a Reuleaux triangle, although different Reuleaux shapes may be used in other embodiments. In the embodiment of FIG. 13, the material used for the end cap 1104 also forms the sealing member 1118.

FIG. 14 shows a spin-on cartridge type filter element, shown as filter element 1200, which may be used, for example, as a lube oil filter. The filter element 1200 includes a Reuleaux-shaped gasket, shown as gasket 1218, disposed on an axial end of the filter element 1200 (e.g., on an upper surface of a retainer 1220 (e.g., nutplate, etc.) at an open end of the filter housing 1222 (e.g., shell, etc.)). The gasket 1218 is disposed on an upper side 1219 (e.g., outer side, etc.) of the retainer 1220 and substantially surrounds a plurality of inlet and/or outlet openings of the retainer 1220. The gasket 1218 extends upwardly from the upper side 1219 in an axial direction away from the media pack. The gasket 1218 forms an axial sealing member for the filter element 1200. The gasket 1218 engages a sealing surface of a filter head that is the same shape as the gasket 1218 when the filter element 1200 is fully installed onto the filter head. During installation, a user threadably engages the filter element 1200 with the filter head and tightens the filter element 1200 to compress the gasket 1218 between the retainer and the sealing surface. The user continues to rotate the gasket 1218 to align the gasket 1218 with the sealing surface. In some embodiments, the filter element 1200 and/or filter head includes alignment indicators (e.g., tabs, markers, etc.) or another clocking feature that engages with the filter element 1200 and/or that may be referenced by a user to ensure that the gasket 1218 is fully aligned with the sealing surface on the filter head (e.g., to ensure that the filter element 1200 is installed in the correct rotational position with respect to the filter head).

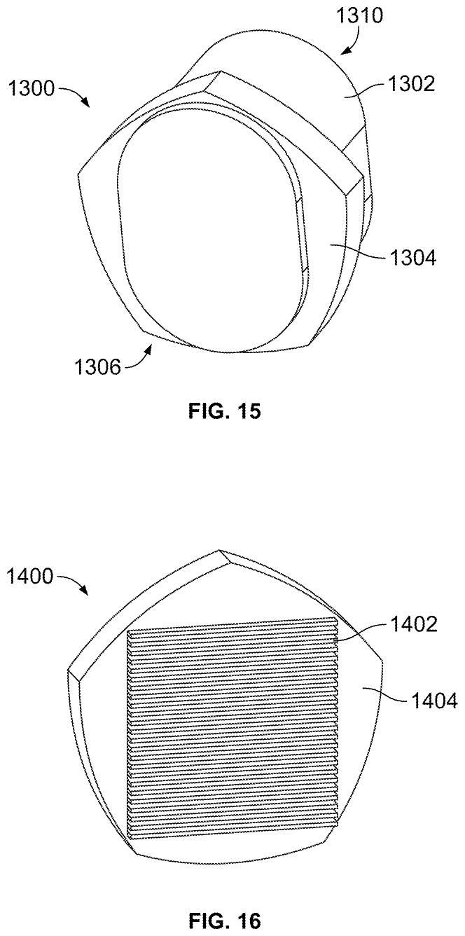

The Reuleaux-shape sealing member geometry may also be used on non-cylindrical filter element designs. For example, FIG. 15 shows a filter element 1300 having a media pack 1302 that is arranged in an oval or racetrack shape. The media pack 1302 may be made from a pleated (e.g., a flat sheet of media formed into an accordion shape, having “V” shaped pleats, etc.) or non-pleated (e.g., corrugated) filter media. In the embodiment of FIG. 15, the filter element 1300 is an axial flow filter element in which a fluid is directed through the media pack 1302 in a substantially axial direction (e.g., parallel to a central axis of the filter element 1300). The filter element 1300 includes an outer sealing flange, shown as flange 1304, extending radially away from the media pack 1302 and surrounding the media pack 1302. The flange 1304 is disposed at an intermediate longitudinal position between opposing ends of the filter element 1300. In the embodiment of FIG. 15, the flange 1304 is disposed proximate to a first end 1306 of the filter element 1300. In other embodiments, the flange 1304 is disposed proximate to a second end 1310 of the filter element 1300, or a central position between opposing ends of the filter element 1300.

As shown in FIG. 15, the flange 1304 is formed in a five-sided Reuleaux shape having five edges and five vertices. The flange 1304 may form an axial sealing member and/or a radially outward facing sealing member, depending on the desired configuration and the design of the filter housing. FIG. 16 shows a filter element 1400 having a media pack 1402 that is arranged in a rectangular/square block (e.g., a panel style filter element formed using pleated media). Similar to the filter element 1300 of FIG. 15, the filter element 1400 of FIG. 16 includes an outer sealing flange, shown as flange 1404 that substantially surrounds the media pack 1402 and that is formed in a five-sided Reuleaux shape. In other embodiments, the sealing member (e.g., flange 1404) may be formed into another Reuleaux shape with more or fewer edges. In one embodiment, the flange 1404 is a curable urethane that the media pack 1402 is potted into, although the flange 1404 may be formed using different manufacturing methods and materials in other embodiments.

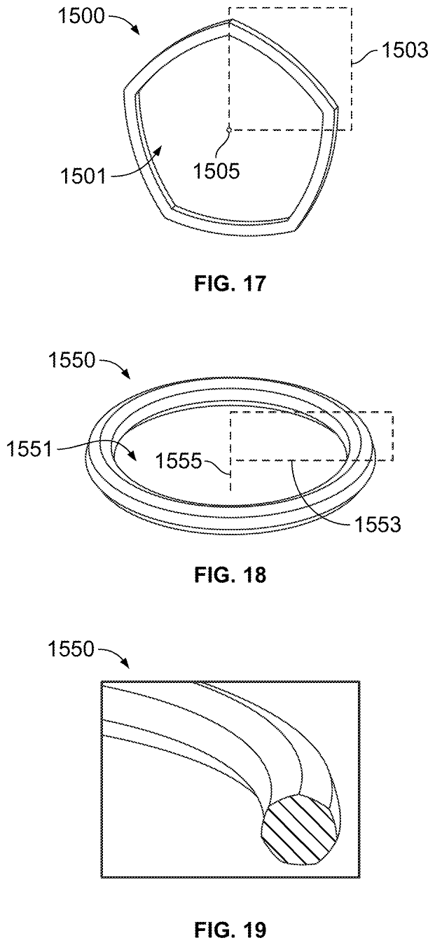

FIGS. 17-19 show various example gaskets that can be used as a sealing member for a filter element. FIG. 17 shows a square cut gasket, shown as gasket 1500 (e.g., a gasket having a substantially rectangular cross-sectional shape, a flat-style gasket, etc.) that may be stamped or otherwise formed from a planar sheet of gasket material (e.g., soft urethane, neoprene, or another suitable material). The gasket 1500 is a closed convex curve that defines a central opening 1501. The overall shape of the gasket 1500, viewed from above the gasket 1500, or along a plane 1503 extending through the gasket 1500 and oriented perpendicular to a central axis 1505 of the central opening 1501, is a Reuleaux shape. In particular, the overall shape of the gasket 1500 is a five-sided Reuleaux shape having five edges and five vertices that together form a perimeter of the central opening 1501.

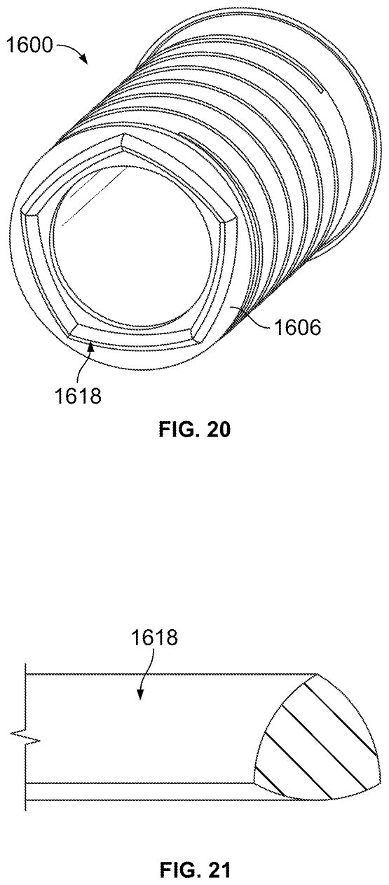

FIGS. 18-19 shows a gasket 1550 that has a Reuleaux-shaped cross-section (e.g., a seven-sided Reuleaux shape). The gasket 1550 may be an 0-ring-type sealing element formed by an extrusion operation using an extrusion die that has the same cross-sectional shape as the gasket 1550. A cross-section of the gasket 1550, taken through the gasket 1550 along a radial reference plane 1553 that is substantially parallel to and extends through a central axis 1555 of the central opening 1551, is formed into a seven-sided Reuleaux shape. A thickness of the gasket 1550 material is approximately constant between any two opposing sides of the cross-section (e.g., between two parallel lines placed on opposing sides of the cross-section). Among other benefits, forming the gasket 1550 with a Reuleaux-shaped cross-section ensures a constant cross-sectional thickness of the gasket 1550 (subject to standard manufacturing tolerances), which promotes uniform contact between the gasket 1550 and the sealing surfaces. The constant cross-sectional thickness also ensures consistent spacing between the filter element and the housing is maintained when using different shapes (e.g., different Reuleaux shapes having the same thickness). As shown in FIG. 18, the overall shape of the gasket 1550, formed by the gasket 1550 along the perimeter of the central opening, is a circular shape. In other embodiments, the overall shape/geometry of the gasket 1550 may be a Reuleaux shape to form a multi-Reuleaux sealing member. For example, FIGS. 20-21 show a filter element 1600 that includes a multi-Reuleaux sealing member 1618 on an axial end of the filter element 1600. As shown in FIG. 20, the multi-Reuleaux sealing member 1618 is a gasket disposed on an end cap 1606 of the filter element 1600 and structured to seal against a filter housing (e.g., a sealing surface in the filter housing) in an axial direction (e.g., parallel to a central axis of the filter element 1600). The overall geometry of the gasket is a five-sided Reuleaux shape. As shown in FIG. 21, the cross-sectional geometry of the gasket is a Reuleaux triangle (e.g., a three-sided Reuleaux shape) having a different number of sides/edges than the overall shape of the gasket. In other embodiments, both the overall shape of the gasket and the cross-sectional shape of the gasket may be the same Reuleaux shape.

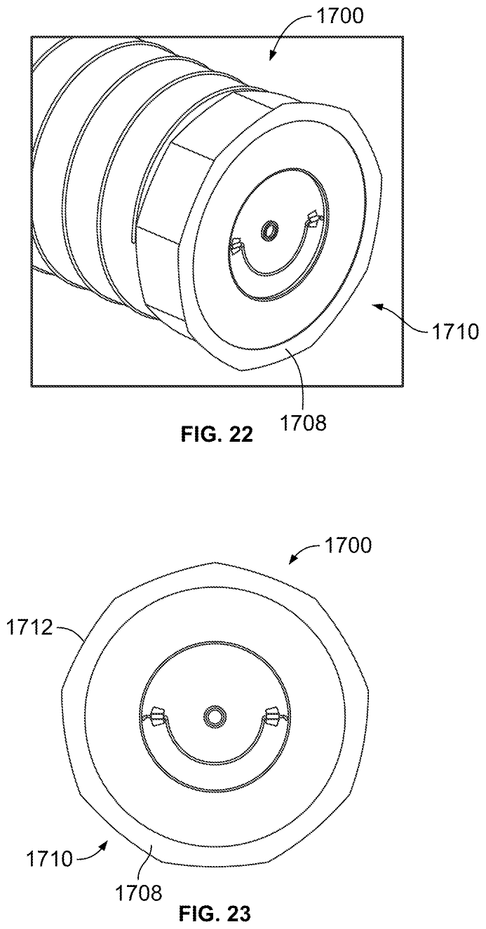

Other components of the filter element may also be formed into Reuleaux-shaped members to minimize pressure drop across the filter element and/or to facilitate “clocking” (e.g., rotational alignment) between the filter element and the filter housing. For example, FIGS. 22-23 show a filter element 1700 that includes a Reuleaux-shaped member on a closed end 1710 of the filter element 1700 that is opposite from an open end (e.g., an inlet/outlet end). In particular, an end cap 1708 of the filter element 1700 is molded, stamped, or otherwise formed into a Reuleaux shape. As shown in FIG. 23, the side edges 1712 of the Reuleaux shape form an outer perimeter of the end cap 1708. In the embodiment of FIGS. 22-23, the end cap 1708 forms a nine-sided Reuleaux shape with nine edges connected by nine vertices. In other embodiments, the end cap 1708 may be formed into a different Reuleaux shape having more or fewer side edges. In one embodiment, the end cap 1708 is shaped to engage with a complementary-shaped flange in the filter housing to rotationally align the filter element 1700 with the filter housing and/or to prevent fitment between the filter housing and a non-genuine filter element.

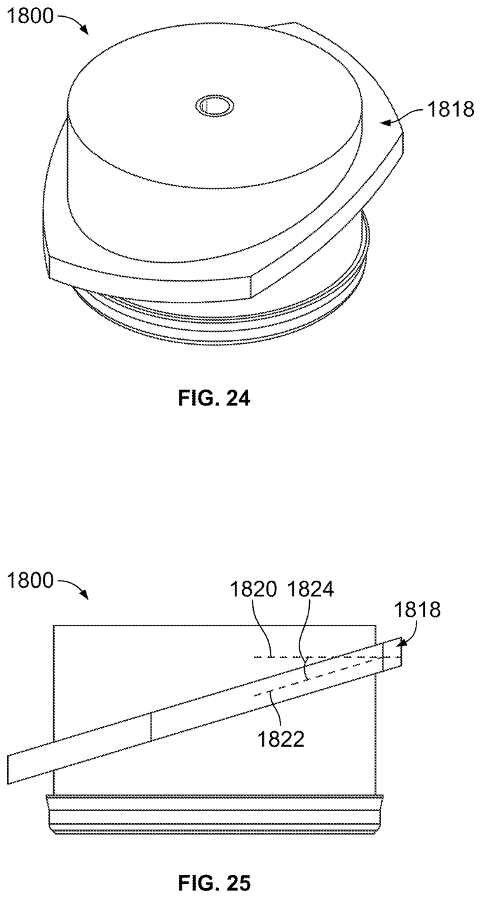

FIGS. 24-25 show a filter element 1800 including a sealing member 1818 that is angled relative to a first reference plane 1820 that is perpendicular to a central axis of the filter element 1800. As shown in FIG. 25, the sealing member 1818 is an outer sealing flange that extends along and is coplanar with a second reference plane 1822. The second reference plane 1822 forms a single, oblique angle 1824 with respect to the first reference plane 1820. In other embodiments, the sealing member 1818 (e.g., flange) is multi-plane angled or skewed relative to the first reference plane 1820, such that the sealing member 1818 does not extend along a single reference plane.

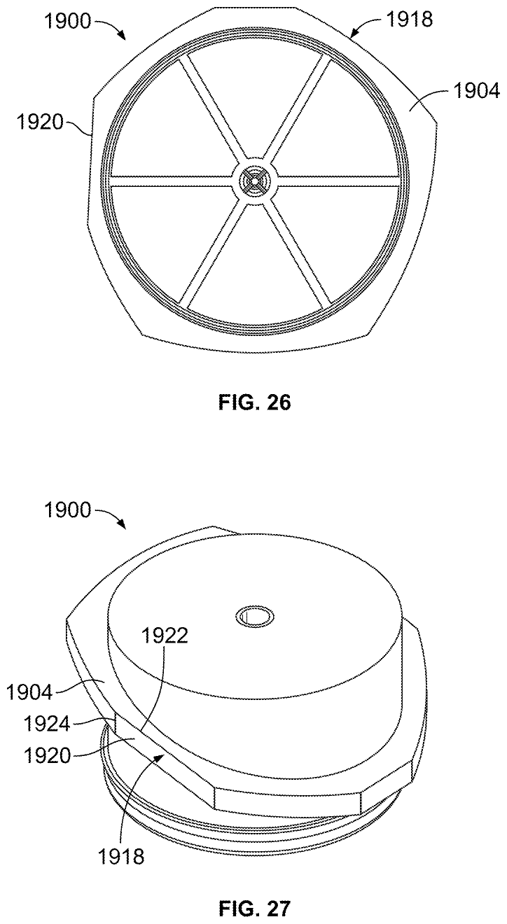

Additional modifications may be made to the Reuleaux-shaped filter element member(s) to further increase variability and complexity. For example, the overall Reuleaux shape formed by the sealing member of the filter element may be truncated or include multiple truncations. FIGS. 26-27 show another example filter element 1900 that includes a truncated Reuleaux-shaped sealing member, shown as sealing member 1918. As shown in FIG. 26 the outer flange 1904 of the filter element 1900 is truncated (e.g., includes a truncation 1920) near a vertex of the Reuleaux shape, which adds an additional edge 1922 and vertex 1924 to the geometry of the sealing member 1918. In some embodiments, the member includes only a single truncation. In other embodiments, the member may include multiple truncations. In one embodiment, the member includes multiple truncations that are symmetrical with one another to form parallel edges on opposing sides of the member. In other embodiments, the truncations may be randomly positioned along the member. As shown in FIG. 27, the sealing member 1918 is also angled relative to the filter element 1900.

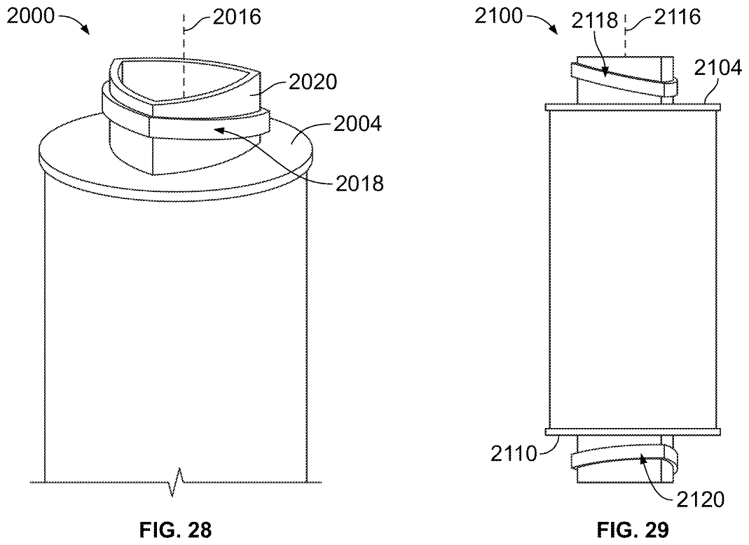

FIG. 28 shows another example filter element 2000 in which the sealing member 2018 is a radially outward facing gasket disposed on an end cap 2004 of the filter element. As with the embodiment described with reference to FIGS. 24-25, the sealing member 2018 of FIG. 28 is disposed at an angle with respect to the filter element 2000 (e.g., a reference plane oriented perpendicular to the central axis 2016 of the filter element 2000). The sealing member 2018 is disposed on an extension piece 2020 that is integrally formed with the end cap 2004 and that extends away from the end cap 2004 in a substantially axial direction.

In some embodiments, the filter element includes multiple Reuleaux-shaped members that engage with different (or the same) members in a filter housing, to further protect against the use of non-genuine filter elements/cartridges. For example, the filter element may include a Reuleaux-shaped sealing member that engages with a complementary (e.g., Reuleaux-shaped) sealing surface in the filter housing, and a Reuleaux-shaped end cap that engages with a complementary (e.g., Reuleaux-shaped) flange in the filter housing.

FIG. 29 shows a filter element 2100 that includes multiple Reuleaux-shaped sealing members, including a first Reuleaux-shaped sealing member, shown as first sealing member 2118, disposed on a first end cap 2104 of the filter element 2100 and a second Reuleaux-shaped sealing member, shown as second sealing member 2120, disposed on a second end cap 2110 of the filter element 2100. In the embodiment of FIG. 29, the first sealing member 2118 and the second sealing member 2120 are both outward facing radial sealing elements that are each shaped as a Reuleaux triangle. In other embodiments, the shape of each one of the sealing members may be different (e.g., the first sealing member may be a Reuleaux triangle while the second sealing member may be a five-sided Reuleaux shape, etc.). As shown in FIG. 29, each of the sealing members may also be angled with respect to the filter element 2100. The angle of the first sealing member may be the same as the second sealing member or different from the second sealing member. In other embodiments, at least one sealing member is arranged in a substantially perpendicular orientation relative to the central axis of the filter element 2100.

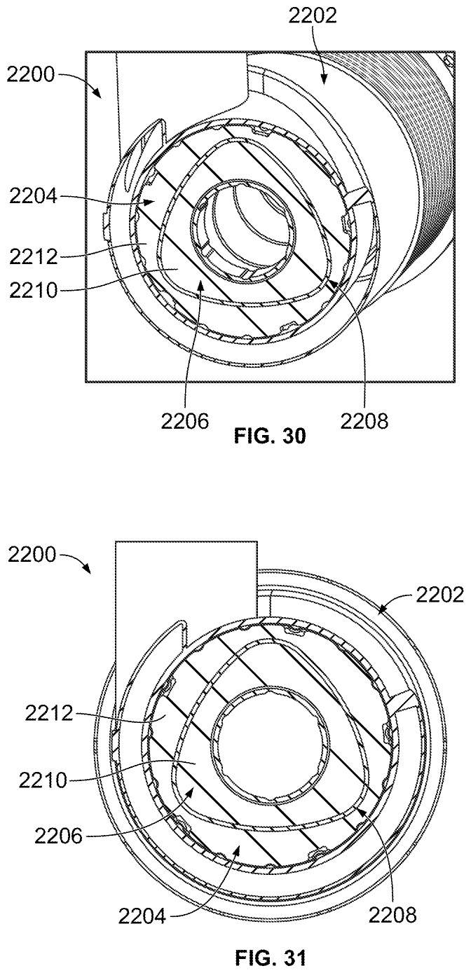

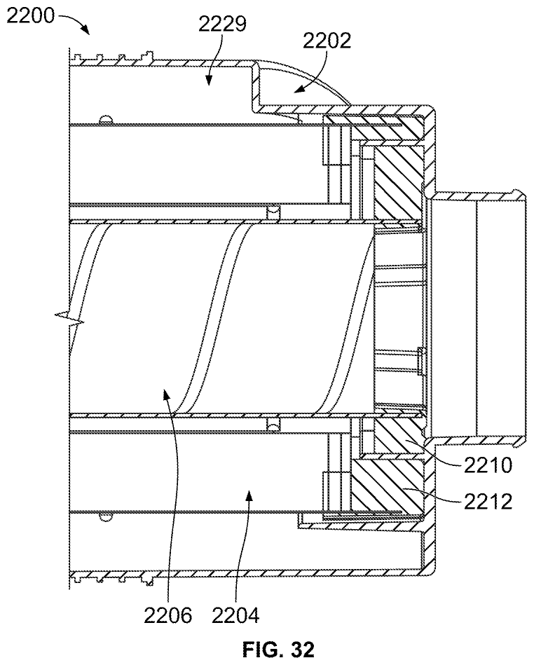

FIGS. 30-32 show a filter assembly 2200 that includes a Reuleaux sealing interface, according to an illustrative embodiment. As shown in FIGS. 30-32, the filter assembly 2200 includes a filter housing 2202 and a filter assembly including a primary filter element 2204 (e.g., outer filter element, etc.) and a secondary filter element 2206 (e.g., inner filter element, safety filter, etc.). As shown in FIGS. 30-31, the filter housing 2202 includes an engagement member 2208 that is “sandwiched” or otherwise disposed between sealing members of the primary filter element 2204 and the secondary filter element 2206 and sealingly engages the sealing members of the primary filter element 2204 and the secondary filter element 2206. The secondary filter element 2206 is nestably engaged with the primary filter element 2204 and is disposed at least partially within a central opening defined by the primary filter element 2204. More specifically, a sealing member 2210 of the secondary filter element 2206 is sized to nestably engage at least one of the engaging member 2208 and/or a sealing member 2212 of the primary filter element 2204.

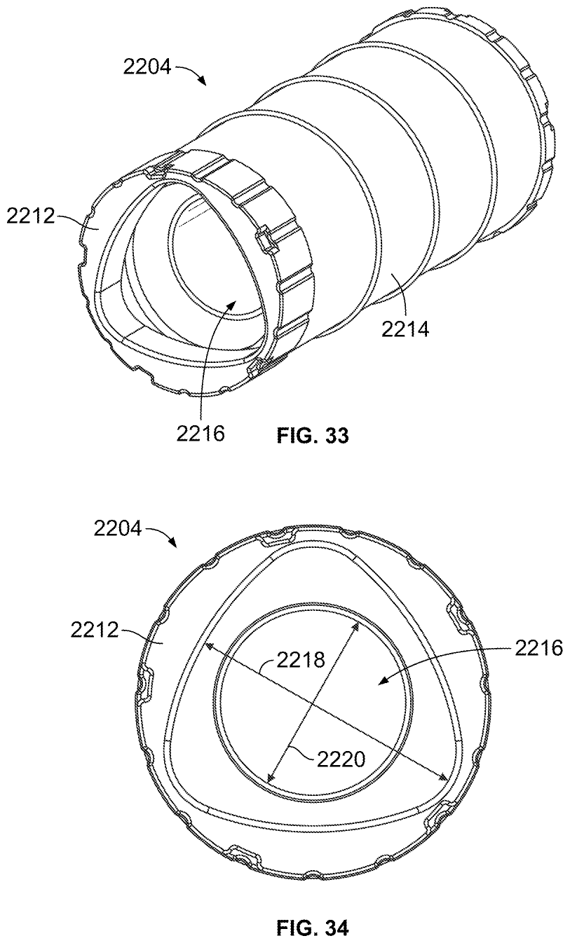

The primary filter element 2204 is a primary filter that is configured to remove contaminants from the fluid entering the intake system. The secondary filter element 2206 is a backup and/or safety filter that is disposed within the primary filter element 2204 and is configured to act as a backup filter to protect the engine in case the primary filter element 2204 becomes damaged, or in case the integrity of the seal between the primary filter element 2204 and the filter housing 2202 is compromised. FIGS. 33-34 show perspective and end views, respectively of the primary filter element 2204. As shown, the primary filter element 2204 includes a media pack 2214 formed in a cylindrical shape. The media pack 2214 defines a central opening 2216 extending along a central axis of the primary filter element 2204 to form a hollow cylindrical cavity that is sized to receive at least a portion of the secondary filter element 2206 therein (see also FIGS. 30-32). The primary filter element 2204 also includes a sealing member 2212 that is formed in a Reuleaux shape. The sealing member 2212 of the primary filter element 2204 is configured to sealingly engage the filter housing along an inner radial surface of the sealing member 2210. The primary filter element 2204 is of similar construction to the filter element 100 described with reference to FIG. 1A. As shown in FIG. 34, a width 2218 of the Reuleaux shape formed by the sealing member 2212 is greater than a width 2220 (e.g., diameter) of an inlet/outlet opening 2222 of the end cap 2224. The change in width between the sealing member 2212 and the end cap 2224 forms a step (e.g., ledge, etc.) that is configured to engage the sealing member 2210 of the secondary filter element 2206 and to prevent axial movement of the secondary filter element 2206.

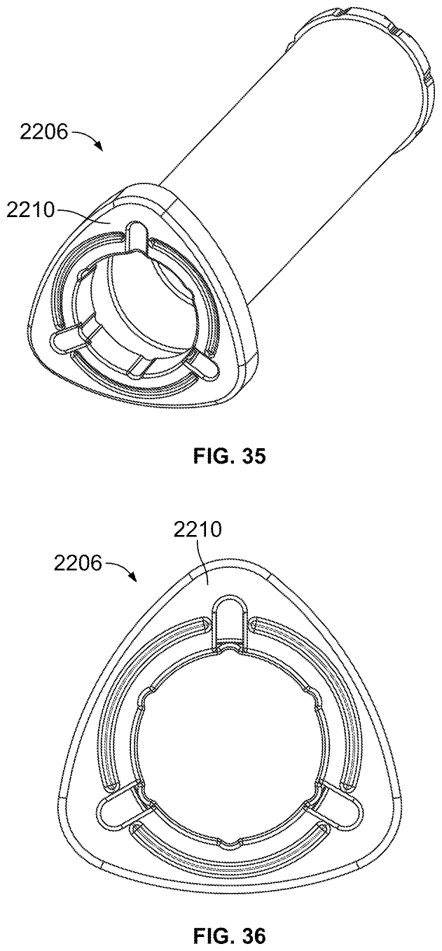

FIGS. 35-36 show perspective and end views, respectively of the secondary filter element 2206. The secondary filter element 2206 includes a sealing member 2210 having a Reuleaux shape that corresponds with and is complementary to the Reuleaux shape formed by primary filter element 2204 (see FIGS. 33-34) and the engagement member of the filter housing. The sealing member 2210 of the secondary filter element 2206 is configured to sealingly engage the filter housing along an outer radial surface of the sealing member 2210.

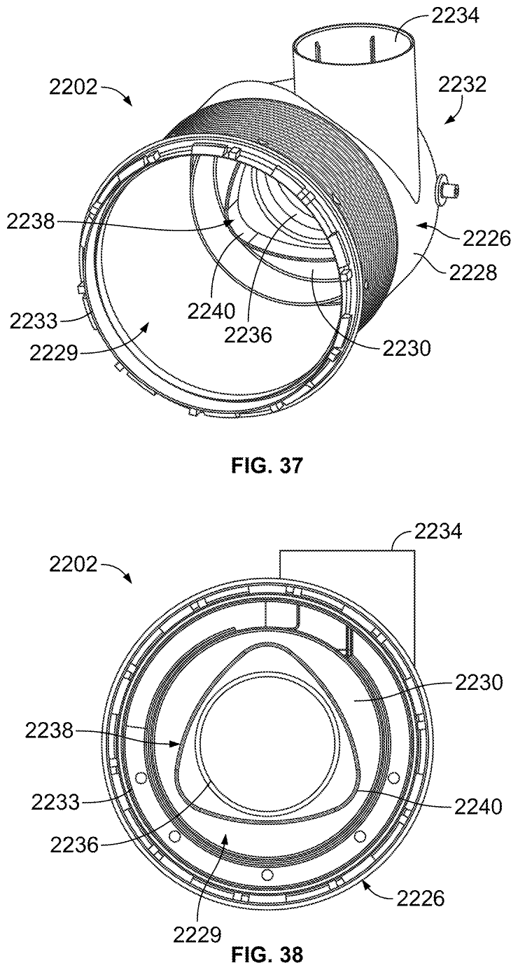

FIGS. 37-38 show perspective and end views, respectively, of the filter housing 2202. The filter housing 2202 includes a body 2226 including a cylindrical side wall, shown as side wall 2228, and an end wall 2230 disposed proximate a first end 2232 of the side wall 2228. Together, the side wall 2228 and the end wall 2230 define a hollow interior cavity 2229 sized to receive the primary filter element and the secondary filter element therein. The body 2226 further defines a service opening 2233 in a second end of the body 2226 opposite the first end 2232, a first port 2234 (e.g., inlet port, inlet opening, etc.) defined by the side wall 2228, and a second port 2236 (e.g., outlet port, outlet opening, etc.) defined by the end wall 2230. The body 2226 also includes fluid connections (e.g., conduits, etc.) at the first port 2234 and the second port 2236 to facilitate coupling with other parts of the filtration system. The filter housing 2202 may also include a cover configured to engage the body 2226 at the service opening 2233.

As shown in FIGS. 37-38, the filter housing 2202 also includes an engagement member 2238 coupled to the end wall 2230 and configured to sealingly engage the sealing member of both the primary filter element and the secondary filter element. The engagement member 2238 includes a flange 2240 (e.g., inner flange) that extends axially away from the end wall 2230 and toward the hollow interior cavity 2229. The flange 2240 is disposed at a central position along the end wall 2230 and circumscribes the second port 2236. A width of the flange 2240 is greater than a width of the second port 2236 and is spaced radially apart from both the second port 2236 and the side wall 2228. The flange 2240 is formed in a Reuleaux shape having an odd number of sides of approximately equal radius. The number of sides and position of the flange 2240 along the body 2226 and/or end wall 2230 may be different in various illustrative embodiments.

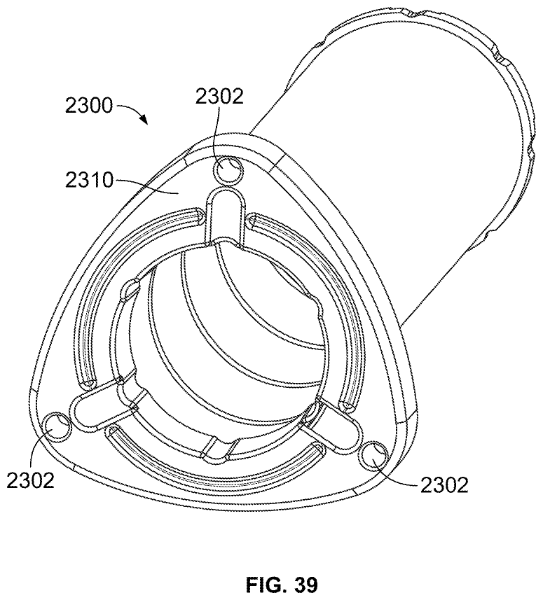

FIG. 39 show another example secondary filter element 2300. The secondary filter element 2300 is substantially similar to the secondary filter element 2206 described with reference to FIGS. 35-36 but also includes a plurality of openings 2302 that extend through the sealing member 2310, from a lower side of the sealing member 2310 to an upper side of the sealing member 2310 opposite the lower side. In the embodiment of FIG. 39, each of the openings 2302 is sized to accommodate a fastener (e.g., a bolt, screw, or another suitable fastener) to facilitate securing the secondary filter element to the filter housing and/or primary filter element. Among other benefits, using additional fasteners to secure the secondary filter element to the filter housing increases the structural integrity of the filter assembly and prevents the secondary filter element from disengaging the flange of the filter housing during replacement of the primary filter element. It will be appreciated that the size, position, and number of openings may be different in various illustrative embodiments.

### IV. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “approximately,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

1. A filter assembly, comprising:
a filter housing comprising an engagement member;
a filter element comprising:
a media pack comprising filter media that is configured to filter a fluid passing therethrough; and
a sealing member coupled to the media pack and engageable with the engagement member, wherein an overall shape of the sealing member, along a plane oriented perpendicular to a central axis of the filter element, is formed in a Reuleaux shape.

2. The filter assembly of claim 1, wherein the sealing member has an odd number of edges that have an approximately equal radius.

3. The filter assembly of claim 1, wherein a distance between two parallel lines positioned on opposing sides of the sealing member and engaging a boundary of the sealing member is approximately equal in any position along the boundary of the sealing member.

4. The filter assembly of claim 1, wherein the sealing member includes curved edges at each vertex of the Reuleaux shape and side edges between each curved edge, and wherein a ratio between a radius of at least one of the curved edges and a radius of at least one of the side edges is within a range between approximately 0 and 0.5.

5. The filter assembly of claim 1, wherein the sealing member defines a central opening, and wherein a cross-section through the sealing member, along a radial reference plane that is substantially parallel to and extends through a central axis of the central opening is formed in the Reuleaux shape.

6. The filter assembly of claim 1, wherein the sealing member defines a central opening that is formed in the Reuleaux shape.

7. The filter assembly of claim 1, wherein the sealing member is angled with respect to a first reference plane that is oriented perpendicular to a central axis of the filter element.

8. The filter assembly of claim 1, wherein the sealing member includes a truncation along an outer perimeter of the sealing member.

9. The filter assembly of claim 1, wherein the filter element further comprises and end cap coupled to an axial end of the media pack, the end cap including a base and an extension piece that extends axially away from the base, the sealing member coupled to the extension piece.

10. The filter assembly of claim 9, wherein the extension piece is formed in the Reuleaux shape.

11. The filter assembly of claim 1, wherein the Reuleaux shape has an approximately constant cross-sectional width.

12. A filter element, comprising:
a media pack comprising filter media that is configured to filter a fluid passing therethrough; and
a sealing member coupled to the media pack, the sealing member engageable with a filter housing to substantially prevent fluid flow past an interface between the sealing member and the filter housing, wherein an overall shape of the sealing member, along a plan oriented perpendicular to a central axis of the filter element, is formed in a Reuleaux shape.

13. The filter element of claim 12, wherein the sealing member has an odd number of edges that have an approximately equal radius.

14. The filter element of claim 12, wherein the sealing member includes curved edges at each vertex of the Reuleaux shape and side edges between each curved edge, and wherein a ratio between a radius of at least one of the curved edges and a radius of at least one of the side edges is within a range between approximately 0 and 0.5.

15. The filter element of claim 12, wherein the sealing member defines a central opening that is formed in the Reuleaux shape.

16. The filter element of claim 12, wherein the sealing member is angled with respect to a first reference plane that is oriented perpendicular to a central axis of the filter element.

17. The filter element of claim 12, wherein the Reuleaux shape has an approximately constant cross-sectional width.

18. A filter housing, comprising:
a side wall;
an end wall disposed at a first end of the side wall, the side wall and end wall together forming an interior cavity; and
a flange coupled to the end wall and oriented normal to the end wall, the flange configured to sealingly engage a sealing member of a filter element, wherein an overall shape of the flange is a Reuleaux shape.

19. The filter housing of claim 18, wherein the Reuleaux shape of the flange is configured to rotationally align a filter element with the filter housing without requiring a separate alignment feature.

20. The filter housing of claim 18, wherein the side wall defines a service opening and a first opening, and the end wall defines a second opening.

21. The filter housing of claim 18, wherein the Reuleaux shape has an odd number of sides, and wherein each side of the Reuleaux shape has an approximately equal radius.

22. The filter housing of claim 18, wherein the engagement member includes curved edges at each vertex of the Reuleaux shape and side edges between each curved edge, and wherein a ratio between a radius of at least one of the curved edges and a radius of at least one of the side edges is within a range between approximately 0 and 0.5.

23. The filter housing of claim 18, wherein the Reuleaux shape has an approximately constant cross-sectional width.
